(19) United States
(12) Patent Application Publication
(10) Pub. No.: US 2024/0278291 A1
(43) Pub. Date: Aug. 22, 2024

(54) PORTABLE WASHING MACHINE

(71) Applicant: HONDA MOTOR CO., LTD., Tokyo (JP)

(72) Inventor: Kentaro Sugimura, Wako-shi, Saitama-ken (JP)

(21) Appl. No.: 18/572,076

(22) PCT Filed: Jun. 22, 2021
(86) PCT No.: PCT/JP2021/023641

§ 371 Date: Dec. 19, 2023

(51) Int. Cl. B08B 3/02; B05B 9/00; H01M 50/247

(52) U.S. Cl. CPC B08B 3/026; B05B 9/007; H01M 50/247; B08B 2203/0223; B08B 2203/027; H01M 2220/30

(57) ABSTRACT

A portable washing machine includes a loading space part provided with a pair of wheels and a handle. The loading space part is loaded with a motor and a pump. The loading space part is also provided with support parts that are provided in front of the pair of wheels and abut against or are separate from the ground. When a virtual straight line that is virtually drawn between rotary centers of the pair of wheels is defined as an axle, the axle is orthogonal to the traveling direction of the loading space part. The center of gravity center of the portable washing machine is positioned above the loading space part and in front of the axle.

### TECHNICAL FIELD

The present invention relates to a portable washing machine which can be carried. More specifically, the present invention relates to an electrically powered portable washing machine that supplies electric power from a battery to a motor.

### BACKGROUND ART

As is well known, a pressure washing machine sprays a high-pressure cleaning liquid onto objects to be washed, such as buildings or vehicle bodies. As this type of pressure washing machine, a portable washing machine that can be carried by human power of a worker is widely used. For example, a pressure washing machine disclosed in JP 2015-120114 A includes a grip portion 52 and a movable grip portion 52a shown in FIG. 1 of JP 2015-120114 A. The user grips the grip portion or the movable grip portion to tilt the housing toward tires 53. In this state, when the user moves the housing toward the tires, the pressure washing machine is carried.

The portable washing machine includes a pump for pressurizing the cleaning liquid, and a pump drive source for driving the pump. Recently, as described in JP 2015-120114 A, a motor is employed as the pump drive source in many cases. In this case, in order to drive the motor, electric power is supplied to the motor. In the pressure washing machine disclosed in JP 2015-120114 A, as described in paragraph [0018], an external power source is used as a power supply source.

When the external power source is a commercial power source, a usable range of the portable washing machine is limited to a range in which the power supply cable can be connected to the outlet. In addition, with the washing machine having a shape as shown in FIGS. 1 to 5 of JP 2015-120114 A, there is a concern that the housing falls down toward the wheels during use.

Therefore, as described in WO 2020/044939 A1, it is conceivable to supply electric power from a battery to a motor. In this case, the battery is mounted on the pressure washing machine. In this pressure washing machine, the entire bottom surface of the housing is grounded. Therefore, there is no concern that the housing will fall down during use.

### SUMMARY OF THE INVENTION

In a pressure washing machine equipped with a motor, a battery, and the like, if the discharge pressure of a cleaning liquid is increased, the motor, the battery, and the like are increased in size. Similarly, if the duration of discharge is increased, the motor, the battery, and the like are increased in size. In this case, the pressure washing machine is considerably heavy. It is a burden for the worker to hold and carry such a heavy pressure washing machine.

Therefore, it is conceivable to prepare a transport vehicle provided with wheels, and carry the pressure washing machine with the transport vehicle. However, even in this case, when the worker places the pressure washing machine on the transport vehicle or stores the pressure washing machine in the transport vehicle, the worker needs to lift the pressure washing machine with human power. In addition, when lifting the pressure washing machine, the worker bends his/her knees, waist, and the like and once bends down. The worker then holds the heavy pressure washing machine and stretches his/her knees, waist, and the like. This motion is also a burden on the worker.

An object of the present invention is to solve the above-mentioned problem.

According to an embodiment of the present invention, there is provided a portable washing machine comprising: a load carrying platform provided with at least one set of wheels, and a handle; a motor mounted on the load carrying platform; and a pump mounted on the load carrying platform and configured to be driven by the motor, the portable washing machine pressurizing a cleaning liquid with the pump, the portable washing machine further comprising: a battery configured to supply electric power to the motor; and a support portion that is provided on the load carrying platform at a position forward of the one set of wheels, is configured to come into contact with or be separated from a ground, and is configured to support the load carrying platform together with the one set of wheels when the support portion is in contact with the ground, wherein when an imaginary straight line imaginarily drawn between rotation centers of the one set of wheels is defined as an axle, a center of gravity of the portable washing machine is located above the load carrying platform and forward of the axle.

According to another embodiment of the present invention, there is provided a portable washing machine comprising: a load carrying platform provided with at least one set of wheels, and a handle; a motor mounted on the load carrying platform; and a pump mounted on the load carrying platform and configured to be driven by the motor, the portable washing machine pressurizing a cleaning liquid with the pump, the portable washing machine further comprising: a battery configured to supply electric power to the motor; and a support portion that is provided on the load carrying platform at a position forward of the one set of wheels, is configured to come into contact with or be separated from a ground, and is configured to support the load carrying platform together with the one set of wheels when the support portion is in contact with the ground, wherein when an imaginary straight line imaginarily drawn between front ends of the one set of wheels is defined as an imaginary front end straight line, and an imaginary straight line imaginarily drawn between rear ends of the one set of wheels is defined as an imaginary rear end straight line, at least a portion of the motor is disposed between the imaginary front end straight line and the imaginary rear end straight line in a plan view, and at least a portion of the battery is disposed forward of the imaginary front end straight line.

Incidentally, “front” refers to a side toward which a worker carrying the portable washing machine advances. That is, “front” is the chest side of the worker. Further, “rear” is the opposite side to the “front” and is the back side of the worker facing forward.

In the present invention, the motor and the battery are mounted at appropriate positions on the load carrying platform. As a result, the center of gravity of the portable washing machine is located more forward (further in the direction approaching the support portion) than the axle imaginarily drawn between the rotation centers of the one set of wheels. As a result, the ground contact state between the support portion and the wheels is favorably maintained. For this reason, it is possible to prevent the portable washing machine from falling backward. In addition, when carrying the portable washing machine, the worker can easily pivot the load carrying platform about the axle. Therefore, it is possible to achieve both self-standing stability of the portable washing machine and portability of the portable washing machine.

In addition, when carrying the portable washing machine, the worker only has to rotate the wheels. That is, there is no need for the worker to hold and carry the portable washing machine. Therefore, the burden on the worker is reduced.

### BRIEF DESCRIPTION OF DRAWINGS

FIG. 1 is an overall schematic perspective view of a portable washing machine according to an embodiment of the present invention as viewed from the left front side;

FIG. 2 is an overall schematic plan view of the portable washing machine as viewed from above;

FIG. 3 is an overall schematic left side view of the portable washing machine as viewed from the left side;

FIG. 4 is a schematic perspective view of a main part when a detachable battery is attached to a battery case and a lock lever provided on the battery case is placed in a removal disabling position;

FIG. 5 is a schematic perspective view of the main part when the lock lever is placed in a removal enabling position; and

FIG. 6 is a schematic side cross-sectional view of another battery case.

### DETAILED DESCRIPTION OF THE INVENTION

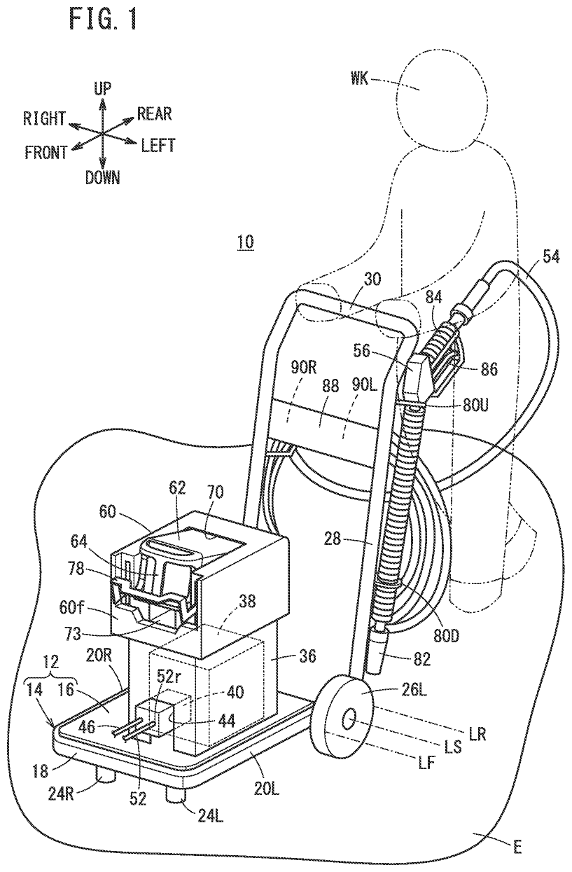

In the following description, “front”, “rear”, “left”, and “right” refer to the front side (chest side), the rear side (back side), the left side, and the right side, respectively, of a worker WK gripping a handle 30 shown in FIG. 1. A portable washing machine 10 moves forward by being pushed forward by the worker WK gripping the handle 30, and moves backward by being pulled backward. That is, the “front-rear direction” means the “traveling direction”. The “left-right direction” is a direction orthogonal to the traveling direction and is synonymous with the width direction.

A “high position” represents a height position at which a linear distance from the ground (road surface) is relatively large. A “low position” represents a height position at which the linear distance from the ground (road surface) is relatively small. The high position and the low position do not necessarily mean that they are arranged one above the other along the vertical direction.

The components shown in the drawings are schematically represented and do not necessarily represent the actual shape and scale.

FIG. 1 is an overall schematic perspective view of the portable washing machine 10 according to the present embodiment as viewed from the left front side. The portable washing machine 10 includes a load carrying platform 12. The load carrying platform 12 includes a main frame 14 and a top plate 16. The top plate 16 is attached to an upper surface of the main frame 14.

The main frame 14 is formed by bending a hollow round pipe into a substantially U-shape. Therefore, the front end of the main frame 14 is a closed end, and the rear end of the main frame 14 is an open end. Accordingly, the main frame 14 includes a front pipe portion 18 located at the foremost position, a left pipe portion 20L located on the left side, and a right pipe portion 20R located on the right side. The front end of the left pipe portion 20L is connected to the left end of the front pipe portion 18, and the front end of the right pipe portion 20R is connected to the right end of the front pipe portion 18. The left pipe portion 20L and the right pipe portion 20R extend rearward. Although not shown, one or more reinforcing pipe portions may be provided between the left pipe portion 20L and the right pipe portion 20R.

A left protruding pipe portion and a right protruding pipe portion that protrude toward a ground E (downward) are provided on a lower surface of the front pipe portion 18. The left protruding pipe portion is located at a predetermined position in a region extending from the intermediate portion of the front pipe portion 18 in the left-right direction to the left end thereof. The left protruding pipe portion is covered with a left support portion 24L made of a rubber material. Similarly, the right protruding pipe portion is located at a predetermined position in a region extending from the intermediate portion of the front pipe portion 18 in the left-right direction to the right end thereof. The right protruding pipe portion is covered with a right support portion 24R made of a rubber material. While the portable washing machine 10 is being used or when the portable washing machine 10 is stopped and temporarily left at the place, the left support portion 24L and the right support portion 24R come into contact with the ground E.

A left wheel 26L is provided on the left side in the vicinity of the rear end of the left pipe portion 20L. Further, a right wheel 26R is provided on the right side in the vicinity of the rear end of the right pipe portion 20R. That is, the portable washing machine 10 includes one set of wheels formed of the left wheel 26L and the right wheel 26R. The left support portion 24L is located forward of the left wheel 26L. The right support portion 24R is located forward of the right wheel 26R. Note that the left wheel 26L and the right wheel 26R are always in contact with the ground E regardless of whether the portable washing machine 10 is traveling or stopped.

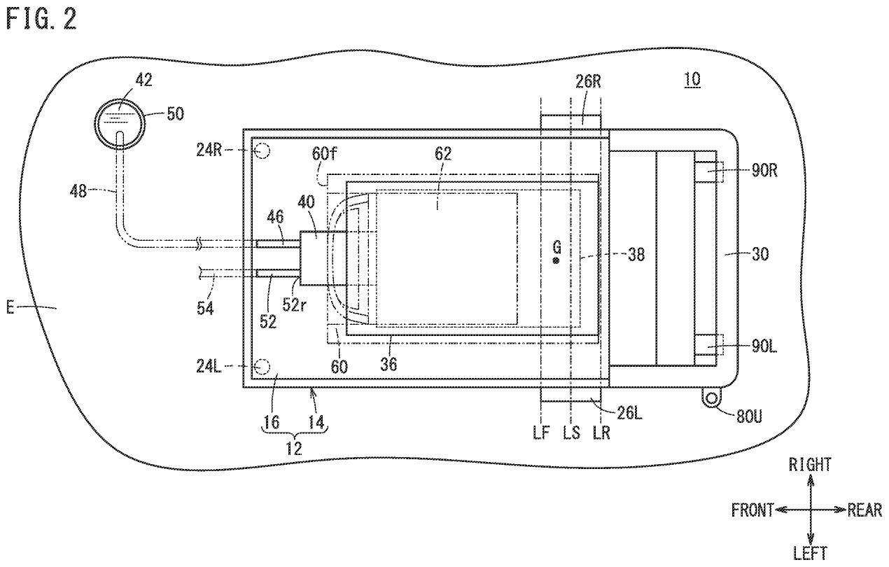

As shown in FIG. 2, the left wheel 26L and the right wheel 26R are positioned parallel to each other in the left-right direction (width direction) of the load carrying platform 12. That is, when an imaginary straight line connecting the rotation center of the left wheel 26L and the rotation center of the right wheel 26R is defined as an axle LS, the axle LS is orthogonal to the traveling direction. Note that the reference sign LF indicates an imaginary front end straight line imaginarily drawn between the front ends of the left wheel 26L and the right wheel 26R. The imaginary front end straight line LF is located forward of the axle LS. The reference sign LR indicates an imaginary rear end straight line imaginarily drawn between the rear ends of the left wheel 26L and the right wheel 26R. The imaginary rear end straight line LR is located rearward of the axle LS.

As shown in FIG. 1, a handle frame 28 is provided integrally with the main frame 14 at the rear end of the main frame 14. The handle frame 28 is inclined at a predetermined angle with respect to the vertical direction and the horizontal direction. The upper end of the handle frame 28 forms the handle 30 extending in the width direction. In other words, the handle 30 is provided on the load carrying platform 12. When the worker WK grips the handle 30 and moves forward or backward, the portable washing machine 10 moves forward or backward.

A housing 36 is positioned and fixed to the top plate 16 via bolts or the like (not shown). An entire motor 38 and most part of a pump 40 are housed within the housing 36. In this manner, the motor 38 and the pump 40 are mounted on the load carrying platform 12. The pump 40 is driven by the motor 38. The pump 40 pressurizes a cleaning liquid. Since this configuration is known, detailed illustration and description thereof will be omitted. A typical example of the cleaning liquid is water 42 shown in FIG. 2. Alternatively, the cleaning liquid may be a mixed liquid of the water 42 and a cleaning chemical.

In the present embodiment, the pump 40 is disposed at the lower portion of a front surface (one side surface facing forward) of the motor 38. Here, a cutout 44 is formed in the housing 36. A portion of the pump 40 is exposed to the outside of the housing 36 through the cutout 44. A water supply pipe 46 is provided on a front end surface of the exposed portion of the pump 40. As shown in FIG. 2, one end of a water supply hose 48 is connected to the water supply pipe 46. The other end of the water supply hose 48 is immersed in the water 42 stored in a storage tank 50. A cleaning agent may be added to the water 42.

A discharge pipe 52 is provided on the front end surface of the above-described portion of the pump 40. The discharge pipe 52 is disposed at substantially the same height as the water supply pipe 46. Alternatively, the discharge pipe 52 may be disposed at a high positioner, for example, diagonally right above the water supply pipe 46. A washing gun 56 is connected to the discharge pipe 52 via a discharge hose 54. The water 42 is pumped through the water supply hose 48 and the water supply pipe 46. The water 42 is discharged to an object to be washed from the washing gun 56 through the discharge pipe 52 and the discharge hose 54.

As shown in FIG. 2, a rear end 52r of the discharge pipe 52 is located forward of a front end 60f of a battery case 60 described later. Therefore, when the discharge hose 54 covering the discharge pipe 52 reaches the rear end 52r of the discharge pipe 52, the position of a rear end of the discharge hose 54 is the position of the rear end 52r of the discharge pipe 52. The rear end of the discharge hose 54 is not located rearward of the rear end 52r of the discharge pipe 52. Therefore, the rear end of the discharge hose 54 is located forward of the front end 60f of the battery case 60.

The motor 38 is disposed within the housing 36 at a position proximate to a rear wall of the housing 36. The motor 38 is larger and heavier than the pump 40.

As shown in FIG. 1, the battery case 60 is provided on an upper surface (one side surface facing upward) of the housing 36 at a position lower than the handle 30. The battery case 60 is a detachable battery storage unit. A detachable battery 62 is detachably stored in the battery case 60. This feature will be described.

In this case, the detachable battery 62 has a substantially rectangular parallelepiped shape as in FIG. 1 of JP 2019-068720 A. A grip portion 64 is provided at one longitudinal end of the detachable battery 62. The worker WK grips the grip portion 64 when storing the detachable battery 62 in the battery case 60, or when carrying the detachable battery 62, for example. The other longitudinal end of the detachable battery 62 where the grip portion 64 is not provided is a substantially flat bottom surface 66. The bottom surface 66 is provided with a first connector 68 that is a female connector.

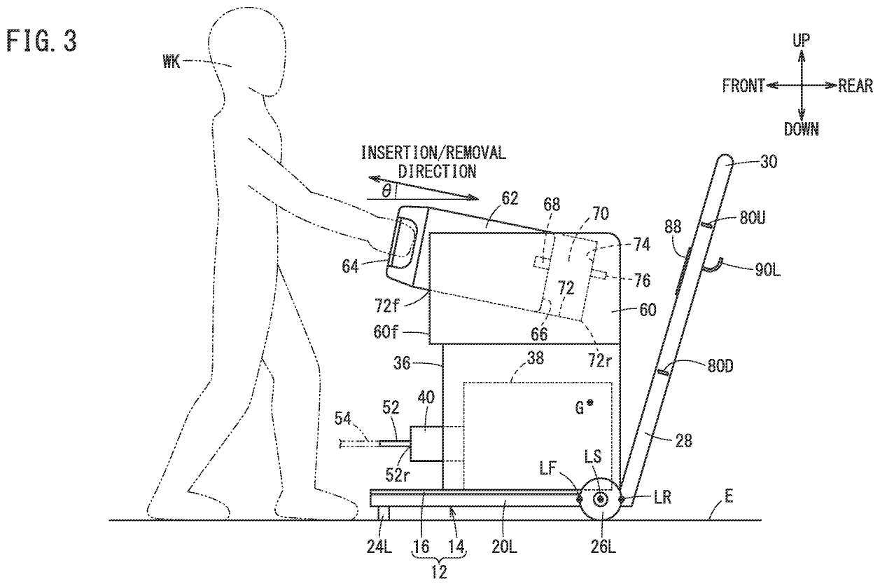

In the battery case 60, an open space whose front and upper sides are open is formed. This open space is a storage space 70 for storing the detachable battery 62. As shown in FIG. 3, a front end 72f of a lower inner wall 72 forming the storage space 70 is located at a position higher than a rear end 72r of the lower inner wall 72. That is, the lower inner wall 72 is inclined so as to become lower as it extends from the front side toward the rear side. An inclination angle e of the lower inner wall 72 with respect to the horizontal direction is preferably 10° to 15°. In this case, part of the load of the detachable battery 62 is received (borne) by the lower inner wall 72. In this state, the detachable battery 62 can be pushed into the storage space 70. Alternatively, the detachable battery 62 can be pulled out of the storage space 70. An insertion opening 73 (see FIG. 1) through which the worker WK can insert his/her hand is formed in the front end 72f of the lower inner wall 72.

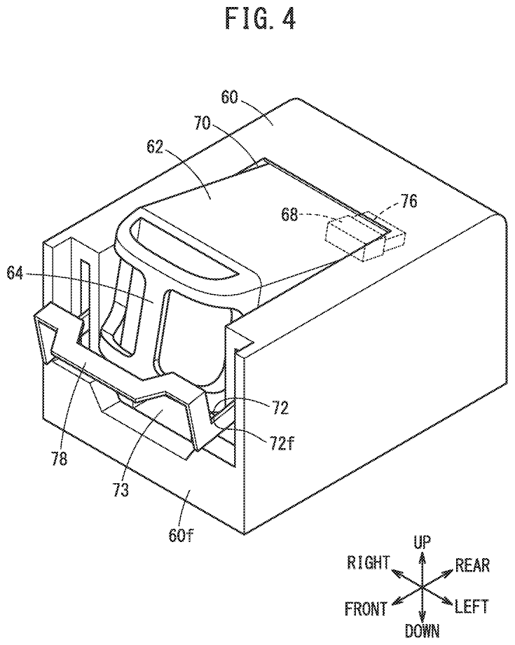

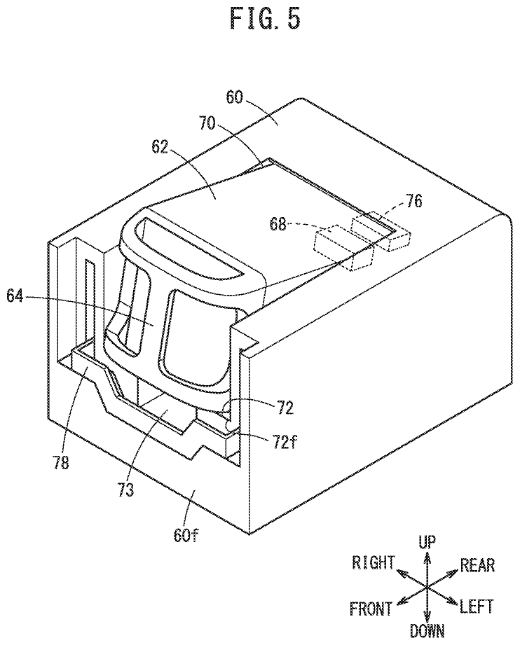

A second connector 76 that is a male connector is provided on a rear inner wall 74 (see FIG. 3) of the storage space 70. The second connector 76 detachably engages with the first connector 68. Specifically, when a lock lever 78 is at an upper removal disabling position shown in FIG. 4, the second connector 76 is exposed from the rear inner wall 74 and engages with the first connector 68. On the other hand, when the lock lever 78 is pivoted toward a lower removal enabling position shown in FIG. 5, the second connector 76 is retracted and lowered from a front high position toward a rear low position. In accordance with this motion, the second connector 76 is detached from the first connector 68 and is then embedded in the rear inner wall 74.

In the detachable battery 62 stored in the storage space 70, the grip portion 64 faces forward and the bottom surface 66 faces rearward. In addition, the detachable battery 62 in the storage space 70 is slightly inclined. That is, the grip portion 64 located on the front side is at a high position and the bottom surface 66 located on the rear side is at a low position. When the detachable battery 62 is stored in the storage space 70 or when the detachable battery 62 is removed from the storage space 70, the detachable battery 62 slides along the lower inner wall 72. Since the lower inner wall 72 is inclined as described above, the sliding (moving) direction of the detachable battery 62 intersects with both the vertical direction and the horizontal direction at a predetermined inclination angle. Hereinafter, the moving direction of the detachable battery 62 is also referred to as an “insertion/removal direction”.

More specifically, the inclination from the front high position to the rear low position corresponds to the insertion direction of the detachable battery 62. Conversely, the inclination from the rear low position to the front high position corresponds to the removal direction of the detachable battery 62. An angle formed by the insertion/removal direction and the horizontal direction (front-rear direction) is equivalent to the inclination angle e of the lower inner wall 72 with respect to the horizontal direction.

The lock lever 78 is pivotably provided at a front portion of the battery case 60. When the lock lever 78 is at the removal disabling position shown in FIG. 4, the lock lever 78 is positioned forward of the detachable battery 62. That is, the lock lever 78 is at a position where it interferes with the detachable battery 62 in the insertion/removal direction. Therefore, when an attempt is made to remove the detachable battery 62 from the storage space 70, the lock lever 78 interferes with the detachable battery 62. Accordingly, the detachable battery 62 cannot be removed from the storage space 70.

On the other hand, when the lock lever 78 is at the removal enabling position shown in FIG. 5, the lock lever 78 is deviated from the insertion/removal direction and is located at a position where it does not interfere with the detachable battery 62. Specifically, the lock lever 78 is substantially flush with the front end 72f of the lower inner wall 72. In this position, the lock lever 78 does not interfere with the detachable battery 62. Therefore, the detachable battery 62 can be easily removed from the storage space 70.

As shown in FIG. 2, the front end 60f of the battery case 60 is located more forward than the imaginary front end straight line LF, toward the left support portion 24L and the right support portion 24R. Further, as described above, the front end 60f is located rearward of the rear end 52r of the discharge pipe 52. Therefore, the entire detachable battery 62 stored in the storage space 70 is located rearward of the discharge pipe 52. In other words, the distance by which the discharge pipe 52 protrudes from the pump 40 is greater than the distance by which the front end 60f of the battery case 60 and the front end of the detachable battery 62 protrude from the motor 38.

The rear wall of the housing 36 and a rear wall (rear end portion) of the battery case 60 are located between front ends and rear ends of the left wheel 26L and the right wheel 26R. That is, the rear wall of the housing 36 and the rear wall (rear end portion) of the battery case 60 are located between the imaginary front end straight line LF and the imaginary rear end straight line LR in the traveling direction. The motor 38 is disposed in the vicinity of the rear wall of the housing 36 as described above. Accordingly, at least a portion of the motor 38 overlaps the axle LS in a plan view (see FIG. 2).

When the portable washing machine 10 is viewed from above as shown in FIG. 2, the detachable battery 62 stored in the storage space 70 overlaps the motor 38.

A lower gun holder 80D and an upper gun holder 80U are provided on the left side portion of the handle frame 28. The washing gun 56 is held by the lower gun holder 80D and the upper gun holder 80U. At this time, a discharge tip 82 is located on the lower side, and a grip 84 and an on/off lever 86 are located on the upper side. Further, the handle frame 28 is provided with a plate 88 extending in the width direction. The plate 88 is located below the handle 30. A left hook 90L and a right hook 90R are provided on a rear end surface of the plate 88. The discharge hose 54 is hooked on the left hook 90L and the right hook 90R. One end of the discharge hose 54 is connected to the grip 84. When the cleaning liquid is discharged, the other end of the discharge hose 54 is connected to the discharge pipe 52. However, when the cleaning liquid is not discharged, it is not particularly necessary to connect the other end of the discharge hose 54 to the discharge pipe 52. Note that the water supply hose 48 may be hooked on the left hook 90L and the right hook 90R.

The position of a center of gravity G of the portable washing machine 10 slightly changes depending on whether or not the detachable battery 62 is stored in the storage space 70 of the battery case 60. However, regardless of whether or not the detachable battery 62 is stored in the storage space 70, the center of gravity G is located above the top plate 16, which is a part of the load carrying platform 12, and forward of the axle LS.

The position of the center of gravity G slightly changes also depending on whether or not the washing gun 56 is held by the lower gun holder 80D and the upper gun holder 80U. However, regardless of whether or not the washing gun 56 is held by the lower gun holder 80D and the upper gun holder 80U, the center of gravity G is located above the top plate 16 and forward of the axle LS.

In a state where the detachable battery 62 is removed from the storage space 70 and the washing gun 56 is removed from the lower gun holder 80D and the upper gun holder 80U, the preferred position of the center of gravity G is between the axle LS and the imaginary front end straight line LF. FIGS. 2 and 3 each show a typical example of the preferred position of the center of gravity G.

The portable washing machine 10 according to the present embodiment is basically configured as described above. Next, the operation and effects of the portable washing machine 10 will be described. In the following description, a case where the detachable battery 62 is removed from the battery case 60 and the washing gun 56 is removed from the lower gun holder 80D and the upper gun holder 80U will be described as an example.

When carrying the portable washing machine 10 to the vicinity of the object to be washed, the worker WK grips the handle 30 and pivots the load carrying platform 12 about the axle LS. With this pivot, the front side of the load carrying platform 12 is raised. In addition, the left support portion 24L and the right support portion 24R are separated from the ground E. When the worker WK moves forward in this state, the left wheel 26L and the right wheel 26R rotate from the rear toward the front. As a result, the portable washing machine 10 moves forward.

As described above, the center of gravity G of the portable washing machine 10 is located above the top plate 16 and between the axle LS and the imaginary front end straight line LF. In this case, compared to a case where the center of gravity G is located forward of the imaginary front end straight line LF, it becomes easy to pivot the load carrying platform 12. Further, it becomes easy to separate the left support portion 24L and the right support portion 24R from the ground E. In addition, by rotating the left wheel 26L and the right wheel 26R, the worker WK can carry the portable washing machine 10. That is, the worker WK does not need to lift the portable washing machine 10. For the above reason, even when the weight of the portable washing machine 10 is large, it is possible to easily carry the portable washing machine 10. That is, the portability of the portable washing machine 10 is improved. Therefore, the burden on the worker WK is reduced.

Further, since the detachable battery 62 and the washing gun 56 are removed, the weight of the portable washing machine 10 is small. Therefore, the worker WK can easily push the portable washing machine 10 forward. That is, the pushing force applied to the portable washing machine 10 by the worker WK can be reduced. Accordingly, it is possible to further reduce the burden on the worker WK.

After carrying the portable washing machine 10 to the vicinity of the object to be washed, the worker WK pivots the load carrying platform 12 about the axle LS in such a direction that the front side thereof is lowered. With this pivot, the left support portion 24L and the right support portion 24R come into contact with the ground E. By this contact (ground contact), the portable washing machine 10 is supported on the ground E via the left support portion 24L, the right support portion 24R, the left wheel 26L, and the right wheel 26R. In other words, a so-called four point support is formed.

Here, the center of gravity G of the portable washing machine 10 is located more forward (further in the direction approaching the left support portion 24L and the right support portion 24R) than the axle LS, regardless of the presence or absence of the detachable battery 62, the washing gun 56, and the like. Preferably, the center of gravity G is located between the axle LS and the imaginary front end straight line LF. In particular, in the present embodiment, the motor 38 is located above the left wheel 26L and the right wheel 26R. More specifically, at least a portion of the motor 38 is located between the imaginary front end straight line LF and the imaginary rear end straight line LR in a plan view. In addition, the battery case 60 is provided above the motor 38.

Therefore, the load of the motor 38 and the battery case 60 is applied to the axle LS. Moreover, since at least a portion of the motor 38 and at least a portion of the battery case 60 protrude forward of the axle LS, it becomes easier for the center of gravity G of the portable washing machine 10 to be located more forward than the axle LS. When the detachable battery 62 is inserted into the battery case 60, the load of the detachable battery 62 is also applied to the axle LS, and therefore, it becomes further easier for the center of gravity G to be located more forward than the axle LS. Therefore, the four point support of the portable washing machine 10 can be easily maintained.

That is, in this case, compared to a case where the center of gravity G is located on the axle LS, or compared to a case where the center of gravity G is located more rearward than the axle LS, it is easy for the portable washing machine 10 to maintain the self-standing state. Therefore, when the worker WK releases his/her hands from the handle 30, the handle frame 28 is prevented from pivoting toward the ground E. Thus, the portable washing machine 10 is prevented from falling down.

Next, the worker WK stores the detachable battery 62 in the storage space 70 of the battery case 60. Specifically, the worker WK grips the grip portion 64 of the detachable battery 62 with one hand to lift the detachable battery 62. Further, the worker WK places the other hand on one side surface of the detachable battery 62 to bring the detachable battery 62 into the posture in which the bottom surface 66 is at a slightly lower position and the grip portion 64 is at a slightly higher position.

Thereafter, the worker WK brings the one side surface of the detachable battery 62 into contact with the lower inner wall 72. At this time, the worker WK may insert the hand placed on the one side surface into the insertion opening 73. Thus, the hand of the worker WK is prevented from being caught between the lower inner wall 72 and the detachable battery 62. Then, in this state, the worker WK slides the detachable battery 62 along the lower inner wall 72. The bottom surface 66 of the sliding detachable battery 62 comes into contact with the rear inner wall 74 of the storage space 70. With this contact, the detachable battery 62 is supported by the battery case 60.

It should be noted that, when attaching the detachable battery 62 to the battery case 60, the worker WK goes around to the front of the portable washing machine 10. This is because the front and upper sides of the battery case 60 are open. Thereafter, the worker WK inserts the detachable battery 62 into the storage space 70 from the front side of the battery case 60. This prevents the detachable battery 62 from interfering with the handle frame 28 including the handle 30 and the plate 88 when the detachable battery 62 is inserted into the storage space 70. As described above, in the present embodiment, the battery case 60 is positioned lower than the handle 30, and the handle 30 is positioned so as not to intersect with the insertion/removal direction (moving direction) of the detachable battery 62. Therefore, the detachable battery 62 can be smoothly inserted into the storage space 70.

Moreover, the lower inner wall 72 is inclined so as to become lower toward the rear inner wall 74. Therefore, the detachable battery 62 easily slides on the lower inner wall 72 by its own weight. Accordingly, the force with which the worker WK pushes the detachable battery 62 into the storage space 70 can be made smaller than in a case where the storage space 70 extends in the horizontal direction.

In addition, since the battery case 60 is provided above the housing 36, the worker WK does not need to excessively bend his/her waist, knees, and the like. Therefore, the burden on the worker WK is reduced. Further, workability is improved.

Immediately after the detachable battery 62 is attached to the battery case 60, the lock lever 78 is at the removal enabling position (see FIG. 5). The worker WK inserts his/her hand into the insertion opening 73, grips the lock lever 78, and pivots the lock lever 78 in such a direction that it is raised. As a result, the lock lever 78 is raised so as to be located forward of the grip portion 64, and is located at the removal disabling position. Therefore, the detachable battery 62 cannot be removed from the storage space 70. This is because the detachable battery 62 interferes with the lock lever 78 even if an attempt is made to remove the detachable battery 62 from the storage space 70.

Further, simultaneously with the pivot of the lock lever 78, the second connector 76 moves forward and upward from the rear inner wall 74 of the storage space 70 toward the front high position. That is, the second connector 76 is exposed from the rear inner wall 74 and engages with the first connector 68. Thus, the first connector 68 and the second connector 76 are electrically connected to each other. As a result, electric power can be supplied from the detachable battery 62 to devices such as the motor 38.

Furthermore, at least a portion of the detachable battery 62 attached to the battery case 60 protrudes forward of the axle LS. Therefore, it becomes easy for the center of gravity G of the portable washing machine 10 to be located more forward than the axle LS.

Even after the detachable battery 62 is attached to the battery case 60 in this manner, the center of gravity G of the portable washing machine 10 is located more forward than the axle LS, in the same manner as before the detachable battery 62 is attached to the battery case 60. Preferably, the center of gravity G is located between the axle LS and the imaginary front end straight line LF. That is, the weight of the detachable battery 62 and the like is not excessively applied rearward (toward the side of the handle frame 28). Therefore, also in this case, the four point support of the portable washing machine 10 can be easily maintained. That is, the portable washing machine 10 is prevented from falling down and maintains the self-standing state. In this manner, the portable washing machine 10 is placed.

The worker WK connects one end of the water supply hose 48 to the water supply pipe 46, and immerses the other end thereof in the water 42 in the storage tank 50. The worker WK connects one end of the discharge hose 54 to the discharge pipe 52. When the other end of the discharge hose 54 is not connected to the washing gun 56, the discharge hose 54 is connected to the vicinity of the grip 84 of the washing gun 56. Note that the connection of the water supply hose 48 and the discharge hose 54, and the attachment of the detachable battery 62 to the battery case 60, can be performed in any order.

The worker WK then turns on the switch. As a result, electric power is supplied from the detachable battery 62 to the motor 38, and the pump 40 pumps up the water 42 in the storage tank 50. Thereafter, the worker WK removes the washing gun 56 from the lower gun holder 80D and the upper gun holder 80U, grips the grip 84, and directs the discharge tip 82 of the washing gun 56 toward the object to be washed. The worker WK pulls the on/off lever 86 with fingers in a direction approaching the grip 84. As a result, a valve (not shown) in the washing gun 56 is opened, and the water 42 at high pressure is discharged from the discharge tip 82 of the washing gun 56 toward the object to be washed. As a result, the object to be washed is washed.

While the water 42 is being discharged, the vibration of the pump 40 is transmitted to the load carrying platform 12. There is a concern that the portable washing machine 10 may fall down due to the vibration. However, according to the present embodiment, the center of gravity G of the portable washing machine 10 is located more forward (further in the direction approaching the left support portion 24L and the right support portion 24R) than the axle LS as described above. Therefore, the load carrying platform 12 is sufficiently supported by the left support portion 24L and the right support portion 24R. Accordingly, the concern that the portable washing machine 10 will fall down toward the handle frame 28 is eliminated.

The center of gravity G is preferably located between the axle LS and the imaginary front end straight line LF. Therefore, the center of gravity G is prevented from being excessively shifted forward. Accordingly, the concern that the portable washing machine 10 falls forward is also eliminated.

When the worker WK releases the fingers from the on/off lever 86, the on/off lever 86 is separated from the grip 84 and returns to its original position. In accordance therewith, the valve is closed, whereby the discharge of the water 42 is temporarily stopped.

After the washing is finished, the worker WK drains water from the washing gun 56 or a drain cock. Thus, the water 42 in the discharge pipe 52 and the discharge hose 54 is drained. Thereafter, the worker WK may remove the discharge hose 54 from the discharge pipe 52, wind the discharge hose 54, and hook the discharge hose 54 on the left hook 90L and the right hook 90R. If necessary, the washing gun 56 can be held by the lower gun holder 80D and the upper gun holder 80U.

Here, it is assumed that the worker WK removes the discharge hose 54 from the discharge pipe 52 while forgetting to drain water. Since the water 42 in the discharge pipe 52 and the discharge hose 54 is at high pressure, the removal may cause the water 42 to be spouted.

However, according to the present embodiment, the rear end 52r of the discharge pipe 52 is located forward of the front end 60f of the battery case 60 (and the front end of the detachable battery 62). Therefore, a connecting portion between the discharge pipe 52 and the discharge hose 54 is located forward of the front end 60f of the battery case 60. That is, as shown in FIG. 2, the battery case 60 and the detachable battery 62 do not overlap the connecting portion in a plan view. In addition, the pump 40 is disposed forward of the motor 38. Further, the battery case 60 and the detachable battery 62 are located above the motor 38. Therefore, the connecting portion is separated from the battery case 60 and the detachable battery 62 by a sufficient distance.

Accordingly, even when the water 42 is spouted from the discharge pipe 52 and the discharge hose 54, the water 42 is prevented from reaching the battery case 60 and the detachable battery 62. Further, even if it is assumed that the water 42 reaches the battery case 60, the water 42 is blocked by the lower surface of the battery case 60. In this manner, the detachable battery 62 is prevented from being exposed to water. As a result, for example, occurrence of short circuit, electric leakage, or the like is avoided.

There may be a case where, in order to facilitate attachment and detachment of the detachable battery 62 to and from the battery case 60, at least a portion of the detachable battery 62 is exposed to the outside of the battery case 60 as shown in FIGS. 1 to 5. Even in this case, it is possible to prevent the detachable battery 62 from being exposed to water by adopting the above-described structure. That is, the above-described structure is useful as a structure for facilitating attachment and detachment of the detachable battery 62. Furthermore, the above-described structure is also useful as a structure for preventing the detachable battery 62 from being exposed to water.

When the state of charge (SOC) of the detachable battery 62 decreases, the detachable battery 62 may be replaced with a new, charged detachable battery 62. For example, the new detachable battery 62 may be transported to a location where the portable washing machine 10 is placed, to perform replacement of the detachable battery. Alternatively, the portable washing machine 10 may be transported to a location where the new detachable battery 62 is placed, to perform replacement of the detachable battery.

When performing the replacement, the worker WK goes around to the front of the battery case 60 and pushes down the lock lever 78 to pivot the lock lever 78 from the removal disabling position shown in FIG. 4 to the removal enabling position shown in FIG. 5. Simultaneously with this pivot, the second connector 76 is retracted and lowered from the front high position to the rear low position. In accordance therewith, the second connector 76 is detached from the first connector 68 and is then embedded in the rear inner wall 74.

Next, the worker WK grips the grip portion 64 of the detachable battery 62 positioned in the storage space 70 and pulls up the detachable battery 62 toward the front high position. Since the lower inner wall 72 forming the storage space 70 is inclined, the lower inner wall 72 receives part of the weight of the detachable battery 62. Therefore, when the worker WK pulls up the detachable battery 62 from the storage space 70, the lower inner wall 72 bears the load of the detachable battery 62. For this reason, the force with which the worker WK pulls up the detachable battery 62 from the storage space 70 can be made smaller than in a case where the storage space 70 extends in the vertical direction. By inclining the lower inner wall 72 in this manner, the detachable battery 62 can be easily slid along the lower inner wall 72 also when the detachable battery 62 is removed from the battery case 60.

Also in this removal, the detachable battery 62 is moved toward the side opposite to the side of the handle frame 28. Therefore, the detachable battery 62 pulled out from the storage space 70 does not cross the handle frame 28. This prevents the detachable battery 62 from interfering with the handle frame 28 including the handle 30. Therefore, the detachable battery 62 can be easily removed from the battery case 60.

Thereafter, in the same manner as described above, the worker WK stores the new, charged detachable battery 62 in the storage space 70, and attaches the detachable battery 62 to the battery case 60. Thus, the above-described washing can be resumed.

As described above, the present embodiment discloses the portable washing machine (10) including: the load carrying platform (12) provided with at least one set of wheels (26L, 26R) and the handle (30); the motor (38) mounted on the load carrying platform; and the pump (40) mounted on the load carrying platform and configured to be driven by the motor, the portable washing machine pressurizing the cleaning liquid (42) with the pump, the portable washing machine further including: the battery (62) configured to supply electric power to the motor; and the support portion (24L, 24R) that is provided on the load carrying platform at a position forward of the one set of wheels, is configured to come into contact with or be separated from the ground (E), and is configured to support the load carrying platform together with the one set of wheels when the support portion is in contact with the ground, wherein when an imaginary straight line imaginarily drawn between rotation centers of the one set of wheels is defined as the axle (LS), the center of gravity (G) of the portable washing machine is located above the load carrying platform and forward of the axle.

In this portable washing machine, the motor and the battery are mounted at appropriate positions on the load carrying platform. As a result, the center of gravity of the portable washing machine is located more forward (further in the direction approaching the support portion) than the axle imaginarily drawn between the rotation centers of the one set of wheels. Accordingly, the ground contact state between the support portion and the wheels is favorably maintained. For this reason, it is possible to prevent the portable washing machine from falling backward. That is, the portable washing machine stably stands by itself.

Further, since the center of gravity is located at the above-described position, the worker (WK) can easily pivot the load carrying platform about the axle during carrying the portable washing machine. Therefore, it is possible to achieve both self-standing stability of the portable washing machine and portability of the portable washing machine.

When an imaginary straight line imaginarily drawn between front ends of the one set of wheels is defined as the imaginary front end straight line (LF), the center of gravity is preferably located between the axle and the imaginary front end straight line. In this case, it is also possible to prevent the portable washing machine from falling forward in the traveling direction. Therefore, the portable washing machine more stably stands by itself.

Typically, the battery is a detachable battery that is attachable to and detachable from the load carrying platform. In this case, it is preferable that the center of gravity when the detachable battery is removed is located forward of the axle. As a result, also in a case where the battery is not being attached, the ground contact state between the support portion and the wheels is favorably maintained. Therefore, the portable washing machine is prevented from falling backward.

Further, the present embodiment discloses the portable washing machine (10) including: the load carrying platform (12) provided with at least one set of wheels (26L, 26R) and the handle (30); the motor (38) mounted on the load carrying platform; and the pump (40) mounted on the load carrying platform and configured to be driven by the motor, the portable washing machine pressurizing the cleaning liquid (42) with the pump, the portable washing machine further including: the battery (62) configured to supply electric power to the motor; and the support portion (24L, 24R) that is provided on the load carrying platform at a position forward of the one set of wheels, is configured to come into contact with or be separated from the ground (E), and is configured to support the load carrying platform together with the one set of wheels when the support portion is in contact with the ground, wherein when an imaginary straight line imaginarily drawn between front ends of the one set of wheels is defined as the imaginary front end straight line (LF), and an imaginary straight line imaginarily drawn between rear ends of the one set of wheels is defined as the imaginary rear end straight line (LR), at least a portion of the motor is disposed between the imaginary front end straight line and the imaginary rear end straight line in a plan view, and at least a portion of the battery is disposed forward of the imaginary front end straight line.

Also in such a portable washing machine, the motor and the battery are mounted at appropriate positions on the load carrying platform. Therefore, in the same manner as described above, the center of gravity (G) of the portable washing machine is located more forward (further in the direction approaching the support portion) than the axle imaginarily drawn between the rotation centers of the one set of wheels. Accordingly, the ground contact state between the support portion and the wheels is favorably maintained. That is, the portable washing machine stably stands by itself.

Further, since the center of gravity is located at the above-described position, the worker can easily pivot the load carrying platform about the axle. Therefore, it becomes easy to carry the portable washing machine. Thus, also in this configuration, it is possible to achieve both self-standing stability of the portable washing machine and portability of the portable washing machine.

It is preferable that the battery is provided below or above the motor, and the battery and the motor overlap each other in a plan view of the load carrying platform viewed from the vertical direction. In this configuration, the load of the motor and the battery is applied to the axle. In addition, since at least a portion of the motor and at least a portion of the battery protrude forward of the axle, it becomes easier for the center of gravity of the portable washing machine to be located more forward than the axle. Therefore, the portable washing machine more stably stands by itself.

Preferably, the pump is disposed at one side of the motor, and the battery is disposed at another side of the motor. In this case, the motor is interposed between the battery and the pump. Therefore, even if the cleaning liquid leaks from the pump, the battery is prevented from getting wet with the cleaning liquid. In other words, the battery is protected by the pump.

There is a case where the pump is provided with the discharge pipe (52) through which the cleaning liquid pressurized by the pump flows. In this configuration, the distance by which the discharge pipe protrudes from the pump is preferably greater than the distance by which the end portion of the battery that faces the discharge pipe protrudes from the motor. In this case, the distal end of the discharge pipe and the distal end of the battery are separated from each other. Therefore, even if the cleaning liquid leaks from the discharge pipe, the battery is prevented from getting wet with the cleaning liquid.

Typically, the battery is a detachable battery that is attachable to and detachable from the load carrying platform. In this case, it is preferable that the pump is disposed at a lower portion of a surface of the motor that faces the one side, and the battery is disposed on an upper surface of the motor. In this configuration, even if the cleaning liquid leaks from the pump, it is difficult for the cleaning liquid to wet the battery. Further, when the battery is inserted or removed, the pump is prevented from interfering with the battery.

Preferably, the detachable battery is located below the handle. When the detachable battery is located at such a position, it is not necessary for the worker to lift the detachable battery high from the ground when attaching the detachable battery to the load carrying platform.

When the detachable battery is attached to the load carrying platform, the detachable battery is preferably moved in a direction from a higher position to a lower position. Further, when the detachable battery is detached from the load carrying platform, the detachable battery is preferably moved in a direction from the lower position to the higher position. In this case, the load carrying platform bears part of the weight of the detachable battery. Accordingly, compared to a case where the detachable battery is moved in the horizontal direction, the force applied to the detachable battery by the worker is reduced. Therefore, the burden on the worker is reduced.

The handle is preferably provided at a position where the handle does not intersect with the battery that is being moved. As a result, the handle is prevented from interfering with the battery. Therefore, the battery can be smoothly attached to the load carrying platform. Further, the battery can be smoothly detached from the load carrying platform.

The present invention is not limited to the above disclosure, and various modifications are possible without departing from the essence and gist of the present invention.

For example, the insertion and removal of the detachable battery 62 is not limited to being performed on the front side, and may be performed on the left side or the right side. In a case where the detachable battery 62 to be inserted and removed does not interfere with the handle frame 28, the insertion and removal may be performed on the rear side.

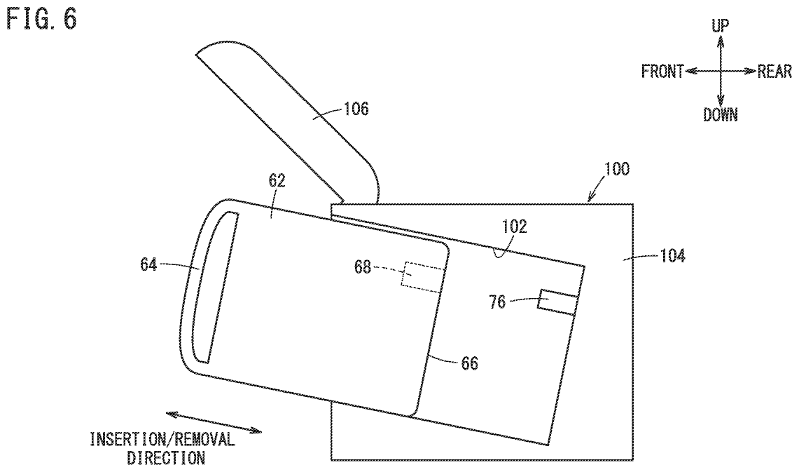

Instead of the battery case 60 illustrated in FIGS. 3 to 5, a battery case 100 shown in FIG. 6 can be employed. The battery case 100 includes a case body 104 in which a storage space 102 is formed, and a lid 106 pivotably provided on the case body 104. After the detachable battery 62 is stored in the storage space 102, the lid 106 is pivoted in such a direction that the lid 106 covers the case body 104 to close the storage space 102.

Each of the battery cases 60 and 100 may be located on the left side or the right side of the motor 38. In the case of the battery case 100, it may be a so-called vertical battery case whose longitudinal direction coincides with the vertical direction. It is not essential to provide the lid 106, and the battery case may be formed only of the case body 104.

Instead of the detachable battery 62, a non-detachable battery pack can be employed.

### REFERENCE SIGNS LIST

10: portable washing machine
12: load carrying platform
14: main frame
16: top plate
24L: left support portion
24R: right support portion
26L: left wheel
26R: right wheel
30: handle
36: housing
38: motor
40: pump
42: water
46: water supply pipe
48: water supply hose
50: storage tank
52: discharge pipe
54: discharge hose
56: washing gun
60, 100: battery case
62: detachable battery
64: grip portion
68: first connector
70, 102: storage space
72: lower inner wall
74: rear inner wall
76: second connector
78: lock lever
E: ground
G: center of gravity
LF: imaginary front end straight line
LS: axle
WK: worker

1. A portable washing machine comprising: a load carrying platform provided with at least one set of wheels, and a handle; a motor mounted on the load carrying platform; and a pump mounted on the load carrying platform and configured to be driven by the motor, the portable washing machine pressurizing a cleaning liquid with the pump,
the portable washing machine further comprising:
a battery configured to supply electric power to the motor; and
a support portion that is provided on the load carrying platform at a position forward of the one set of wheels, is configured to come into contact with or be separated from a ground, and is configured to support the load carrying platform together with the one set of wheels when the support portion is in contact with the ground,
wherein when an imaginary straight line imaginarily drawn between rotation centers of the one set of wheels is defined as an axle, a center of gravity of the portable washing machine is located above the load carrying platform and forward of the axle.

2. The portable washing machine according to claim 1, wherein
when an imaginary straight line imaginarily drawn between front ends of the one set of wheels is defined as an imaginary front end straight line, the center of gravity is located between the axle and the imaginary front end straight line.

3. The portable washing machine according to claim 1, wherein
the battery is a detachable battery that is attachable to and detachable from the load carrying platform, and the center of gravity when the detachable battery is removed is located forward of the axle.

4. A portable washing machine comprising: a load carrying platform provided with at least one set of wheels, and a handle; a motor mounted on the load carrying platform; and a pump mounted on the load carrying platform and configured to be driven by the motor, the portable washing machine pressurizing a cleaning liquid with the pump,
the portable washing machine further comprising:
a battery configured to supply electric power to the motor; and
a support portion that is provided on the load carrying platform at a position forward of the one set of wheels, is configured to come into contact with or be separated from a ground, and is configured to support the load carrying platform together with the one set of wheels when the support portion is in contact with the ground,
wherein when an imaginary straight line imaginarily drawn between front ends of the one set of wheels is defined as an imaginary front end straight line, and an imaginary straight line imaginarily drawn between rear ends of the one set of wheels is defined as an imaginary rear end straight line, at least a portion of the motor is disposed between the imaginary front end straight line and the imaginary rear end straight line in a plan view, and
at least a portion of the battery is disposed forward of the imaginary front end straight line.

5. The portable washing machine according to claim 4, wherein
the battery is provided below or above the motor, and the battery and the motor overlap each other in a plan view of the load carrying platform viewed from a vertical direction.

6. The portable washing machine according to claim 1, wherein
the pump is disposed at one side of the motor, and the battery is disposed at another side of the motor.

7. The portable washing machine according to claim 6, wherein
the pump is provided with a discharge pipe through which the cleaning liquid pressurized by the pump flows, and a distance by which the discharge pipe protrudes from the pump is greater than a distance by which an end portion of the battery that faces the discharge pipe protrudes from the motor.

8. The portable washing machine according to claim 6, wherein
the battery is a detachable battery that is attachable to and detachable from the load carrying platform, the pump is disposed at a lower portion of a surface of the motor that faces the one side, and the battery is disposed on an upper surface of the motor.

9. The portable washing machine according to claim 8, wherein
the battery is located below the handle, the battery is moved in a direction from a higher position to a lower position when the battery is attached, and the battery is moved in a direction from the lower position to the higher position when the battery is detached.

10. The portable washing machine according to claim 9, wherein
the handle is provided at a position where the handle does not intersect with the battery that is being moved.

11. The portable washing machine according to claim 4, wherein
the pump is disposed at one side of the motor, and the battery is disposed at another side of the motor.

12. The portable washing machine according to claim 11, wherein
the pump is provided with a discharge pipe through which the cleaning liquid pressurized by the pump flows, and a distance by which the discharge pipe protrudes from the pump is greater than a distance by which an end portion of the battery that faces the discharge pipe protrudes from the motor.

13. The portable washing machine according to claim 11, wherein
the battery is a detachable battery that is attachable to and detachable from the load carrying platform, the pump is disposed at a lower portion of a surface of the motor that faces the one side, and the battery is disposed on an upper surface of the motor.

14. The portable washing machine according to claim 13, wherein
the battery is located below the handle, the battery is moved in a direction from a higher position to a lower position when the battery is attached, and the battery is moved in a direction from the lower position to the higher position when the battery is detached.

15. The portable washing machine according to claim 14, wherein
the handle is provided at a position where the handle does not intersect with the battery that is being moved.
